(19) United States
(12) Patent Application Publication
(10) Pub. No.: US 2019/0180262 A1
(43) Pub. Date: Jun. 13, 2019

(54) TRANSACTION METHOD AND SYSTEM FOR VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: LI HUANG, Wuhan (CN); JUN-JIE QUAN, Wuhan (CN); MAO-LIN XIA, Wuhan (CN)

(21) Appl. No.: 15/989,314

(22) Filed: May 25, 2018

(30) Foreign Application Priority Data
Dec. 7, 2017 (CN) 201711286607.0

(51) Int. Cl. G06Q 20/18; G07F 11/00; G06Q 20/22; G06Q 20/40; G06Q 20/20; G06Q 20/32

(52) U.S. Cl. CPC G06Q 20/18; G07F 11/002; G06Q 20/227; G06Q 20/407; G06K 9/6202; G06Q 20/409; G06Q 20/3276; G06Q 20/203; G06Q 20/204

(57) ABSTRACT

A system for processing purchase of commodities from a vending machine comprises a transaction detecting module, a control module, a transaction verification module, a display module, and a commodity dispensing module. In allowing one type of payment for commodities, the system prevents other payment types being used. The transaction module detects a transaction request and the control module obtains commodity information and a payment method that is user-selected, other payment methods then being forbidden. The transaction verification module verifies whether a payment is made under the selected payment method. If the payment is successful, the commodity dispensing module controls the vending machine to dispense commodity, if not, the display module controls a touch screen to output transaction failure information. A transaction method of the vending machine is also provided.

The subject matter herein generally relates to systems and methods for processing commodity transaction information of vending machines.

### BACKGROUND

A vending machine may automatically dispense items such as snacks, beverages, lottery tickets, and consumer products, after the customer inserts currency or a credit card to the machine. The vending machine may support one or more payment methods, but duplicate payments may occur if a user misoperates the machine.

### BRIEF DESCRIPTION OF THE DRAWINGS

Implementations of the present technology will now be described, by way of example only, with reference to the attached figures.

FIG. 1 is an operating environment diagram of an embodiment of a vending machine.

FIG. 2 is a block diagram of an embodiment of the vending machine of FIG. 1.

FIG. 3 is a block diagram of an embodiment of a transaction system of the vending machine of FIG. 1.

FIG. 4 is a block diagram of another embodiment of the transaction system of the vending machine of FIG. 1.

FIG. 5 is a flow diagram of an embodiment of a method of the vending machine of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “comprising,” when utilized, means “including, but not necessarily limited to”; it specifically indicates open-ended inclusion or membership in the so-described combination, group, series, and the like.

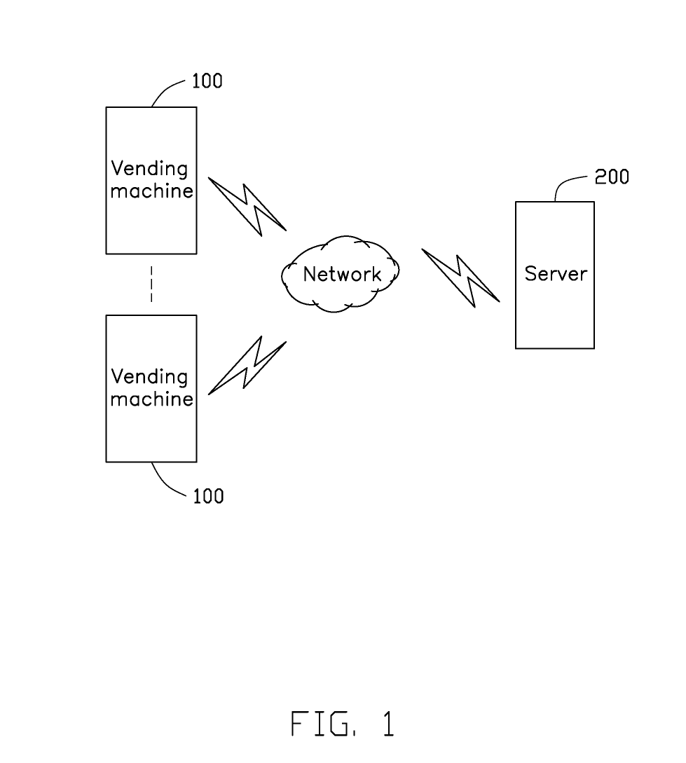

FIG. 1 illustrates an operating environment diagram including a vending machine 100 in accordance with an embodiment. The vending machine 100 may communicate with a server 200 through a wireless network such as a WIFI network, a GPRS network, or a 3G/4G network. The server 200 may manage and monitor a plurality of vending machines 100. The server 200 may obtain operation information, transaction information, and inventory information of the vending machine 100.

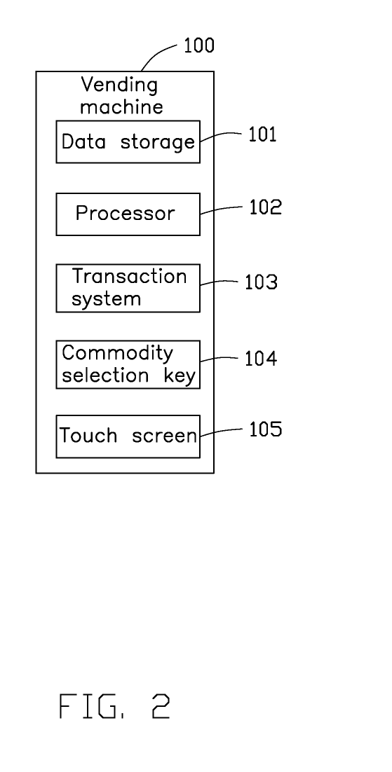

Referring to FIG. 2, the vending machine 100 may comprise at least one data storage 101, at least one processor 102, and a transaction system 103. The transaction system 103 is configured to process commodity transaction information of the vending machine 100.

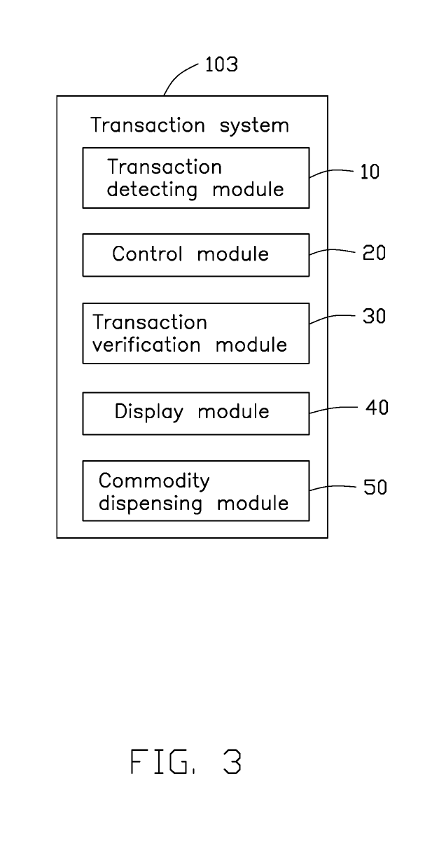

Referring to FIG. 3, the transaction system 103 may comprise a plurality of modules, such as a transaction detecting module 10, a control module 20, a transaction verification module 30, a display module 40, and a commodity dispensing module 50. The modules 10-50 may comprise one or more software programs in the form of computerized codes stored in the data storage 101. The computerized codes may include instructions that can be executed by the processor 102 to provide functions for the modules 10-50.

In one embodiment, the data storage 101 can be in the vending machine 100, or can be a separate external memory card, such as an SM card (Smart Media Card), an SD card (Secure Digital Card), or the like. The data storage 101 can include various types of non-transitory computer-readable storage mediums. For example, the data storage 101 can be an internal storage system, such as a flash memory, a random access memory (RAM) for temporary storage of information, and/or a read-only memory (ROM) for permanent storage of information. The data storage 101 can also be an external storage system, such as a hard disk, a storage card, or a data storage medium. The processor 102 can be a central processing unit (CPU), a microprocessor, or other data processor chip that performs functions of the vending machine 100.

The transaction detecting module 10 is configured to detect and determine whether the vending machine 100 receives a transaction request.

In one embodiment, the vending machine 100 may sell types of commodities. For example, the types of commodities can comprise drinks, snacks, electronic products, and daily necessities. The vending machine 100 may comprises a plurality of commodity selection keys 104 and each commodity selection key 104 corresponds to a type of commodity. When one of the commodity selection keys 104 is pressed, the transaction detecting module 10 determines that the vending machine 100 receives the transaction request.

In one embodiment, the vending machine 100 may comprise a touch screen 105, a user may touch commodity icons of the touch screen 105 to select commodities.

In one embodiment, if an available number of a first type of commodity is zero, the commodity selection key 104 or the touch screen 105 cannot receive a purchase request of the first type of commodity.

The control module 20 is configured to obtain commodity information in response to the vending machine 100 receiving a transaction request. A payment method that is selected in a payment selection interface of the machine 100 is further obtained by the control module 20 and other payment methods are forbidden.

In one embodiment, the commodity information may comprise commodity names, commodity prices, and goods channel information.

In one embodiment, the payment selection interface can be displayed in the touch screen 105, the payment selection interface may comprise a plurality of payment methods. When the transaction detecting module 10 determines that the vending machine 100 has received the transaction request, the display module 40 controls the touch screen 105 to display the payment selection interface.

In one embodiment, the plurality of payment methods may comprise a card payment method, a scan payment method, and a cash payment method. The card payment method may comprise at least one of bank card pay, city smart card pay (public traffic card), and work card pay. The scan payment method may comprise one or more of Wechat pay, Alipay, and Apple pay. The cash payment method may comprise at least one of coin pay and paper currency pay. When the control module 20 receives a first payment method selected by the user, the control module 20 forbids other payment methods. For example, if the card payment method is selected by the user, the control module 20 forbids the scan payment method and the cash payment method. If the transaction request is not closed, the user can reselect a payment method through the payment selection interface.

In one embodiment, if the card payment method is selected, the control module 20 activates a card reader (not shown) and can control a loudspeaker (not shown) to output a first audible instruction of “please swipe card”, which can also be displayed on the touch screen 105. If the scan payment method is selected, the display module 40 may control the touch screen 105 to display QR codes for payment. The control module 20 may control the loudspeaker to output a second audible instruction of “please scan code”, which can also be displayed on the touch screen 105. If the cash payment method is selected, the control module 20 may control the loudspeaker to output a third audible instruction of “please insert cash”, which can also be displayed on the touch screen 105.

The transaction verification module 30 can determine whether a payment of the transaction request is successful.

In one embodiment, when the card payment method is selected, the transaction verification module 30 verifies whether the card payment of the transaction request is successful during a first predetermined time period. The first predetermined time period is started when the touch screen 105 displays or the loudspeaker provides the instruction of “please swipe card”. For example, the first predetermined time period can be set as 20 seconds. During the first predetermined time period, if the card payment of the transaction request is unsuccessful, the user can swipe card again. After the first predetermined time period, if the card payment of the transaction request is still unsuccessful, the transaction verification module 30 can determine that the card payment method is failed, and the display module 40 can control the touch screen 105 to display a first transaction failed information. The vending machine 100 can reenter the sale mode to receive a new transaction request.

In one embodiment, the first transaction failed information may be “invalid card”, “no available credit/credit limit reached”, or “deduction failed”.

During the first predetermined time period, if the card payment of the transaction request is successful, the display module 40 controls the touch screen 105 to display a first payment information. The first payment information may comprise commodity name, sale price and balance information. For example, if the card payment of the transaction request is the bank card, the touch screen 105 displays the commodity name and the sale price. If the card payment of the transaction request is the city card or the timecard, the touch screen 105 displays the commodity name, the sale price and the balance information.

In one embodiment, when the scan payment method is selected, the transaction verification module 30 verifies whether the scan payment of the transaction request is successful during a second predetermined time period. The second predetermined time period can start when the touch screen 105 displays or the loudspeaker outputs the second audible instruction of “please scan code”. For example, the second predetermined time period can be set as 60 seconds. During the second predetermined time period, if the scan payment of the transaction request is unsuccessful, the user can scan code again. After the second predetermined time period, if the scan payment of the transaction request is still unsuccessful, the transaction verification module 30 can determine that the scan payment of the transaction request is unsuccessful, and the display module 40 controls the touch screen 105 to display a second transaction failed information. The vending machine 100 can reenter the sale mode to receive a new transaction request.

In one embodiment, the second transaction failed information may be “network malfunction/network anomaly” or “deduction failed”.

During the second predetermined time period, if the scan payment of the transaction request is successful, the display module 40 controls the touch screen 105 to display a second payment information. The second payment information may comprise commodity name and consumption amount information.

In one embodiment, when the cash payment method is selected, the display module 40 can control the touch screen 105 to display a current total cash amount. The transaction verification module 30 can determine whether the cash payment of the transaction request is successful during a third predetermined time period. The third predetermined time period can start when the touch screen 105 displays or the loudspeaker outputs the third audible instruction of “please insert cash”. For example, the third predetermined time period can be set as 60 seconds. During the third predetermined time period, if the cash payment of the transaction request is unsuccessful, the user can insert cash again. After the third predetermined time period, if the cash payment of the transaction request is still unsuccessful, the transaction verification module 30 can determine that the cash payment of the transaction request is unsuccessful, and the display module 40 controls the touch screen 105 to display a third transaction failed information. The vending machine 100 refunds any cash inserted and can reenter the sale mode to receive a new transaction request.

In one embodiment, the third transaction failed information may comprise: “insufficient cash inserted”, “unable to give change”, or “invalid cash.

During the third predetermined time period, if the cash payment of the transaction request is successful, the vending machine 100 can give out change, and the display module 40 can control the touch screen 105 to display a third payment information. The third payment information may comprise commodity name, sale price, and amount of change.

In one embodiment, the user can insert cash before sending a transaction request to the vending machine 100. The touch screen 105 may comprise a return key icon, and if the payment of the transaction is not made, the user can reselect a commodity for purchasing.

When the payment of the transaction request is successful, the commodity dispensing module 50 controls the vending machine 100 to dispense commodities according to the commodity information of the transaction request.

In one embodiment, when the payment of the transaction request is successful, the commodity dispensing module 50 dispenses one or more commodities.

In one embodiment, the commodity dispensing module 50 is further configured to determine whether the dispensing of a commodity by the vending machine 100 is successful after successful payment. If the vending machine 100 dispenses the commodity successfully, the control module 20 records and stores transaction information. If the dispensing of a commodity is unsuccessful, the control module 20 returns deducted amount through the original payment path, and the display module 40 controls the touch screen 105 to display refund information. The refund information may be “delivery failed, please wait for refund, if refund failed, please contact customer service”.

For example, when the transaction request is paid by WeChat, the control module 20 can return the deducted amount through the WeChat. When the transaction request is paid by cash, the control module 20 can return the inserted amount through a cash return device of the vending machine 100.

In one embodiment, the vending machine 100 may comprise (not shown) an infrared ray detection module or an ultrasonic wave detection module. The commodity dispensing module 50 can communicate with the infrared ray detection module to detect a commodity be delivered to an output position, etc., to determine whether a dispensing of a commodity by the vending machine 100 is successful.

In one embodiment, when the dispensing of a commodity is successful, the current transaction request is closed. When the transaction detecting module 10 determines that a new transaction request is received, the control module 20 controls the vending machine 100 to enter the sale mode and repeal payment methods previously forbidden. Until the transaction detecting module 10 determines that a new transaction request is received, the control module 20 controls the vending machine 100 to enter a self-inspection mode.

In one embodiment, when the vending machine 100 enters the self-inspection mode, the vending machine 100 can detect and determine whether each function module is operating normally. The vending machine 100 can reenter the sale mode after each function module is determined to be operating normally. When one or more function modules are determined to be operating abnormally, the vending machine 100 can enter and show an abnormal mode and suspend trading.

In one embodiment, when the vending machine 100 does not detect a trigger event during a predetermined time period, the control module 20 can control the vending machine 100 to enter an advertising mode. When the vending machine 100 is in the advertising mode, the touch screen 105 is configured to display advertisements. When the vending machine 100 detects a trigger event, the control module 20 controls the vending machine 100 to enter the sale mode.

In one embodiment, the trigger event may comprise detecting an object approaching the vending machine 100, detecting a pressing of the commodity selection key 104 of the vending machine 100, detecting the touch screen 105 of the vending machine 100 being touched, or detecting the insertion of cash. The predetermined time period may be set as 120 seconds.

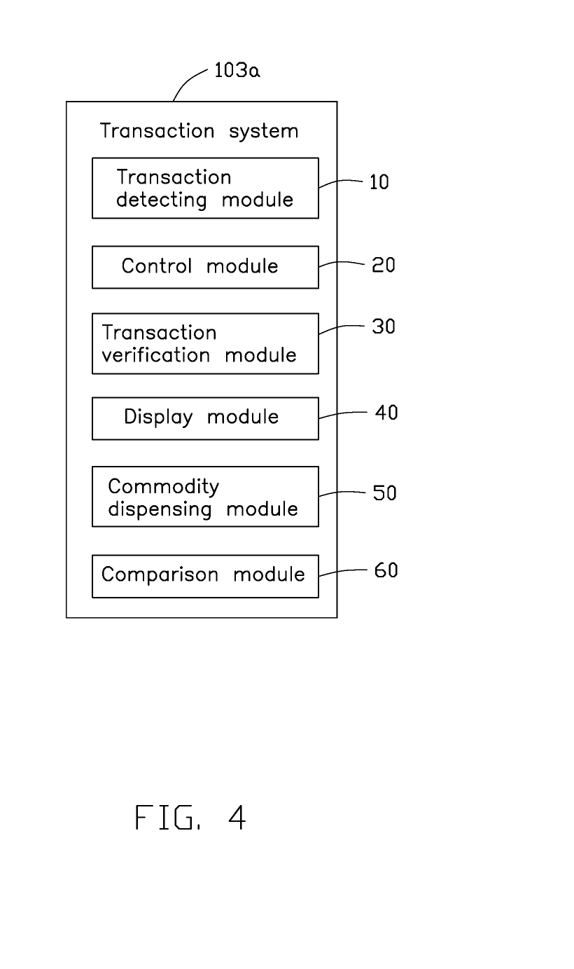

Referring to FIG. 4, the transaction system 103a comprises the transaction detecting module 10, the control module 20, the transaction verification module 30, the display module 40, the commodity dispensing module 50, and a comparison module 60. The comparison module 60 can determine a change in commodity amounts. When the comparison module 60 determines that a commodity amount is changed, the control module 20 can update an inventory information of a goods channel.

For example, a camera (not shown) may be set inside of the vending machine 100. A first image of inventory information of the vending machine 100 is captured in a first time period t1 and a second image of the inventory information of the vending machine 100 is captured in a second time period t2. The comparison module 60 may compare the first image with the second image to determine whether a change in commodity amounts. A time period difference between the first time period t1 and the second time period t2 is less than a time period t3. The time period t3 can be 20 seconds or 30 seconds.

In one embodiment, the first time period t1 may be a first transaction time period of the vending machine 100, and the second time period t2 may be a time period of a next transaction of the vending machine 100.

In one embodiment, the control module 20 may update the inventory information of the vending machine 100 according to the stored transaction information and a total inventory.

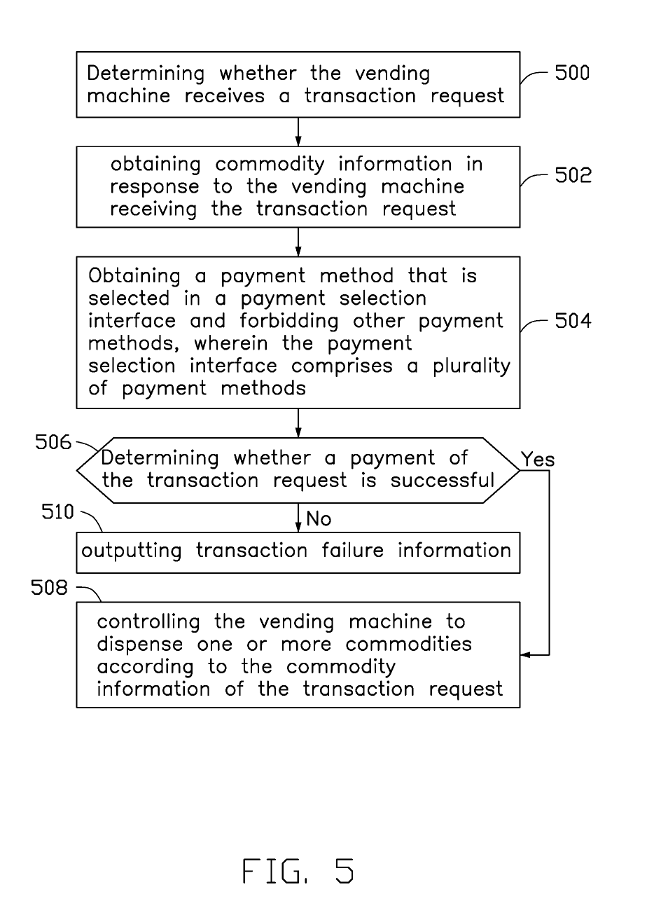

FIG. 5 illustrates one embodiment of a method of the vending machine 100. The flowchart presents an embodiment of the method. The method is provided by way of example, as there are a variety of ways to carry out the method. The method described below can be carried out using the configurations illustrated in FIGS. 3 and 4, for example, and various elements of these figures are referenced in explaining the example method. Each step shown in FIG. 5 may represent one or more processes, methods, or subroutines, carried out in the example method. Furthermore, the illustrated order of steps is illustrative only and the order of the steps may change. Additional steps may be added or fewer steps may be utilized, without departing from this disclosure. The example method may begin at step 500.

In step 500, the transaction detecting module 10 determines whether the vending machine 100 receives a transaction request.

In step 502, the control module 20 obtains commodity information in response to the vending machine 100 receiving the transaction request.

In step 504, the control module 20 obtains a payment method that is selected in a payment selection interface and forbids other payment methods. The payment selection interface comprises a plurality of payment methods.

In step 506, the transaction verification module 30 verifies whether a payment of the transaction request is successful.

In step 508, the commodity dispensing module 50 controls the vending machine 100 to dispense one or more commodities according to the commodity information of the transaction request in response to the payment of the transaction request being successful.

In step 510, the display module 40 controls the touch screen 105 to output transaction failure information in response to the payment of the transaction request being unsuccessful.

The embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A transaction method of a vending machine comprising:
determining whether the vending machine receives a transaction request;
obtaining commodity information in response to the vending machine receiving the transaction request;
obtaining a payment method that is selected in a payment selection interface and forbidding other payment methods, wherein the payment selection interface comprises a plurality of payment methods;
determining whether a payment of the transaction request is successful; and
controlling the vending machine to dispense one or more commodities according to the commodity information of the transaction request in response to the payment of the transaction request being successful.

2. The transaction method of claim 1, further comprising:
outputting transaction failure information in response to the payment of the transaction request being unsuccessful.

3. The transaction method of claim 1, further comprising:
determining whether the vending machine detects a trigger event;
controlling the vending machine to enter a sale mode in response to detecting the trigger event; and
controlling the vending machine to enter an advertising mode in response to no trigger event being detected;
wherein the trigger event comprises detecting an object approaching the vending machine, detecting a pressing of commodity selection key of the vending machine, detecting a touch screen of the vending machine being touched, or detecting the insertion of cash.

4. The transaction method of claim 1, further comprising:
determining whether the vending machine dispenses the one or more commodities successfully;
recording and storing transaction information in response to the vending machine dispensing the commodity successfully; and
returning deducted amount through the original payment path and outputting refund information in response to the vending machine dispensing the commodity unsuccessful.

5. The transaction method of claim 1, wherein the plurality of payment methods comprise a card payment method, a scan payment method, and a cash payment method, the transaction method further comprises:
activating a card reader and verifying whether a card payment is successful during a first predetermined time period in response to the card payment method being selected; and
outputting a first transaction failed information in response to the card payment being unsuccessful.

6. The transaction method of claim 5, further comprising:
generating a quick response (QR) code and verifying whether a scan payment is successful during a second predetermined time period in response to the scan payment method being selected; and
outputting a second transaction failed information in response to the scan payment being unsuccessful.

7. The transaction method of claim 5, further comprising:
displaying a total cash amount and verifying whether a cash payment is successful during a third predetermined time period in response to the cash payment method being selected; and
outputting a third transaction failed information and refunding cash in response to the cash payment being unsuccessful.

8. The transaction method of claim 1, further comprising:
determining whether a new transaction request is received in response to the transaction request being closed;
controlling the vending machine to enter the sale mode and repealing the payment methods previously forbidden in response to receiving a new transaction request; and
controlling the vending machine to enter a self-inspection mode in response to no new transaction request being received.

9. The transaction method of claim 1, further comprising:
obtaining a first image and a second image of each goods channel of the vending machine that are captured in adjacent time periods;
comparing the first image with the second image to determine whether a change in commodity amounts; and
updating inventory information of the vending machine in response to the commodity amounts of a first goods channel being changed.

10. A transaction system of a vending machine comprising:
at least one processor;
a storage; and
one or more programs that are stored in the storage and executed by the at least one processor, the one or more programs comprising instructions for:
determining whether the vending machine receives a transaction request;
obtaining commodity information in response to the vending machine receiving the transaction request;
obtaining a payment method that is selected in a payment selection interface and forbidding other payment methods, wherein the payment selection interface comprises a plurality of payment methods;
determining whether a payment of the transaction request is successful; and
controlling the vending machine to dispense one or more commodities according to the commodity information of the transaction request in response to the payment of the transaction request being successful.

11. The transaction system of claim 10, wherein the one or more programs further comprise:
outputting transaction failure information in response to the payment of the transaction request being unsuccessful.

12. The transaction system of claim 10, wherein the one or more programs further comprise:
determining whether the vending machine detects a trigger event;
controlling the vending machine to enter a sale mode in response to detecting the trigger event; and
controlling the vending machine to enter an advertising mode in response to no trigger event being detected;
wherein the trigger event comprises detecting an object approaching the vending machine, detecting a pressing of commodity selection key of the vending machine, detecting a touch screen of the vending machine being touched, or detecting the insertion of cash.

13. The transaction system of claim 10, wherein the one or more programs further comprise:
determining whether the vending machine dispenses the one or more commodities successfully;
recording and storing transaction information in response to the vending machine dispensing the commodity successfully; and
returning deducted amount through the original payment path and outputting refund information in response to the vending machine dispensing the commodity unsuccessful.

14. The transaction system of claim 10, wherein the plurality of payment methods comprise a card payment method, a scan payment method, and a cash payment method, the one or more programs further comprise:
activating a card reader and verifying whether a card payment is successful during a first predetermined time period in response to the card payment method being selected; and
outputting a first transaction failed information in response to the card payment being unsuccessful.

15. The transaction system of claim 14, wherein the one or more programs further comprise:
generating a quick response (QR) code and verifying whether a scan payment is successful during a second predetermined time period in response to the scan payment method being selected; and
outputting a second transaction failed information in response to the scan payment being unsuccessful.

16. The transaction system of claim 14, wherein the one or more programs further comprise:
displaying a total cash amount and verifying whether a cash payment is successful during a third predetermined time period in response to the cash payment method being selected; and
outputting a third transaction failed information and refunding cash in response to the cash payment being unsuccessful.

17. The transaction system of claim 10, wherein the one or more programs further comprise:
determining whether a new transaction request is received in response to the transaction request being closed;
controlling the vending machine to enter the sale mode and repealing the payment methods previously forbidden in response to receiving a new transaction request; and
controlling the vending machine to enter a self-inspection mode in response to no new transaction request being received.

18. The transaction system of claim 10, wherein the one or more programs further comprise:
obtaining a first image and a second image of each goods channel of the vending machine that are captured in adjacent time periods;
comparing the first image with the second image to determine whether a change in commodity amounts; and
updating inventory information of the vending machine in response to the commodity amounts of a first goods channel being changed.
